(19) United States
(12) Patent Application Publication
(10) Pub. No.: US 2011/0311263 A1
(43) Pub. Date: Dec. 22, 2011

(54) DEVELOPING DEVICE TO PREVENT SCATTERING OF TONER

(75) Inventor: Katsunori Mizuta, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/151,405

(22) Filed: Jun. 2, 2011

Related U.S. Application Data
(60) Provisional application No. 61/355,809, filed on Jun. 17, 2010.

(51) Int. Cl. G03G 15/09; G03G 21/00

(52) U.S. Cl. 399/98; 399/274

(57) ABSTRACT

A developing device includes a developing roller that carries a developer and faces an image carrier, a housing that supports the developing roller and supplies the developer to the developing roller, and a pressure reducing part that exists downstream of an opposite position to the image carrier in a rotation direction of the developing roller, and is formed in a wall of the housing located downstream of an airflow generated in a gap between the developer on the developing roller and an inner wall of the housing.

### CROSS-REFERENCE TO RELATED APPLICATION

This application is based upon and claims the benefit of priority from Provisional U.S. Application 61/355809 filed on Jun. 17, 2010, the entire contents of which are incorporated herein by reference.

### FIELD

Embodiments described herein relate generally to a developing device for developing by using a magnetic brush developing roller in a copying machine, a printer or the like.

### BACKGROUND

As a magnetic brush developing device used in a copying machine, a printer or the like, there is a developing device including an exhaust port in a housing. The exhaust port exhausts the air taken into the housing at the time of rotation of a developing sleeve.

However, when the airflow of the air taken into the housing does not go to the exhaust port, exhaust efficiency from the exhaust port becomes worse and the inner pressure of the housing rises. When the inner pressure of the housing rises, the airflow is ejected from a gap of the housing, and there is a fear that floating toner in the housing, together with the airflow, is scattered to and contaminates the surrounding of the housing.

Thus, the development of a developing device to prevent floating toner in a housing from being scattered to the surrounding at the time of rotation of a developing sleeve is desired.

### BRIEF DESCRIPTION OF THE DRAWINGS

FIG. 1 is a schematic structural view showing a main part of a printer of a first embodiment;

FIG. 2 is a schematic structural view showing a developing device of the first embodiment;

FIG. 3 is a schematic explanatory view showing magnetic lines of force around a developing roller and the flow of air by the rotation of the developing roller of the first embodiment;

FIG. 4 is a schematic perspective view of the developing device of the first embodiment;

FIG. 5 is a schematic explanatory view in which a part of the developing device is seen from a photoconductive drum side;

FIG. 6 is a schematic structural view showing a developing device of a second embodiment; and

FIG. 7 is a schematic explanatory view in which a part of the developing device is seen from a photoconductive drum side of a second embodiment.

### DETAILED DESCRIPTION

According to an embodiment, a developing device includes a developing roller that carries a developer and faces an image carrier; a housing that supports the developing roller and supplies the developer to the developing roller; and a pressure reducing part that exists downstream of an opposite position to the image carrier in a rotation direction of the developing roller, and is provided in a wall of the housing located downstream of an airflow generated in a gap between the developer on the developing roller and an inner wall of the housing.

Hereinafter, embodiments will be described.

### FIRST EMBODIMENT

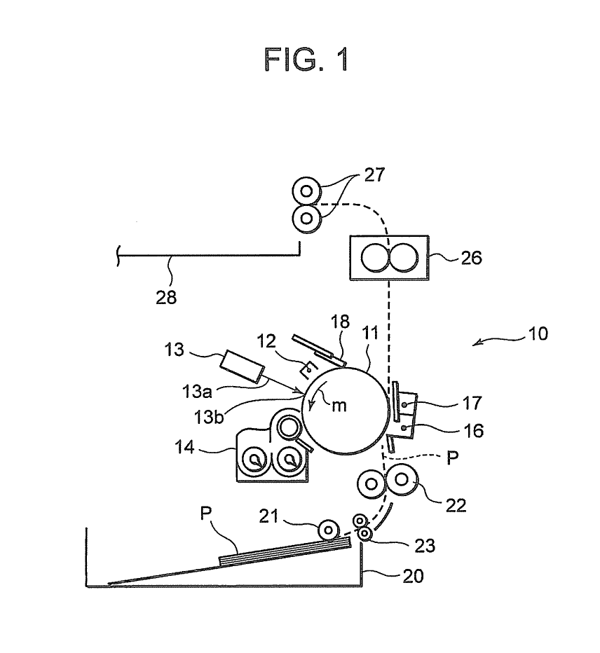

FIG. 1 shows a main part of a printer 10 as an image forming apparatus of a first embodiment. The printer 10 includes a charger 12, an exposure device 13, a developing device 14, a transfer charger 16, a peeling charger 17 and a cleaner 18 around a photoconductive drum 11 as an image carrier rotating in an arrow m direction. The charger 12 and the exposure device 13 constitute a latent image forming part.

The charger 12 uniformly charges the photoconductive drum 11. The exposure device 13 irradiates a laser light 13a to an exposure position 13b of the photoconductive drum 11 charged uniformly based on image data or the like, and forms an electrostatic latent image on the photoconductive drum 11. The developing device 14 supplies toner to the electrostatic latent image on the photoconductive drum 11 and visualizes the electrostatic latent image.

The transfer charger 16 transfers the toner image formed on the photoconductive drum 11 to a sheet P as a recording medium. The peeling charger 17 peels the sheet P, on which the toner image is transferred, from the photoconductive drum 11. The cleaner 18 cleans the toner remaining on the photoconductive drum 11 after the transfer. The sheet P is taken out from a paper feed cassette 20 by a pickup roller 21. The sheet P taken out from the paper feed cassette 20 is conveyed by a separation roller 23 and a register roller 22, and reaches the transfer charger 16 in synchronization with the toner image formed on the photoconductive drum 11.

In the printer 10, the transfer charger 16 transfers the toner image formed on the photoconductive drum 11 to the sheet P. After the transfer is ended, in the printer 10, the peeling charger 17 peels the sheet P from the photoconductive drum 11. The printer 10 includes, at the downstream side of the peeling charger 17 in the conveyance direction of the sheet P, a fixing device 26 and a paper discharge roller 27 to discharge the sheet P after the fixing to a paper discharge part 28. In the printer 10, the fixing device 26 fixes the toner image to the sheet P, and the paper discharge roller 27 discharges the sheet P to the paper discharge part 28.

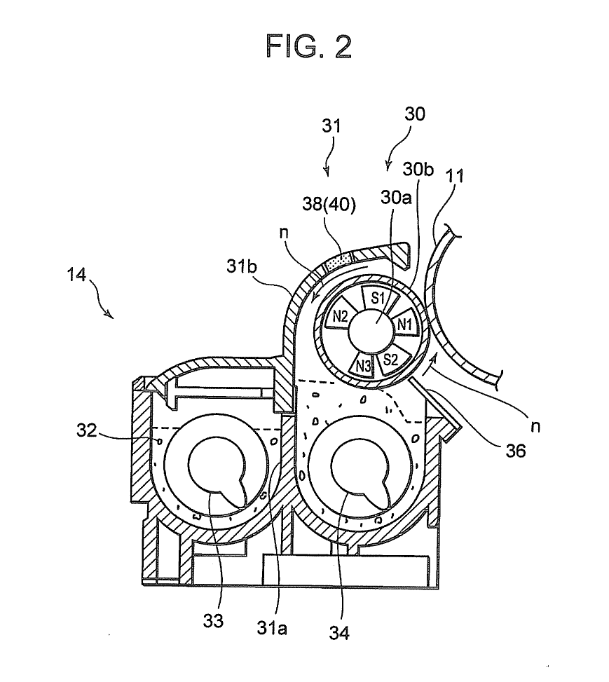

Next, the developing device 14 will be described in detail. As shown in FIG. 2, the developing device 14 includes a housing 31 to support a developing roller 30. The housing 31 contains a two-component developer 32 including a toner and a carrier, which is supplied to the developing roller 30.

The housing 31 includes an agitating mixer 33 and a conveying mixer 34 which are separated by a partition part 31a. The agitating mixer 33 and the conveying mixer 34 agitate the toner and the developer 32 supplied into the housing 31, and circulate and convey the developer 32.

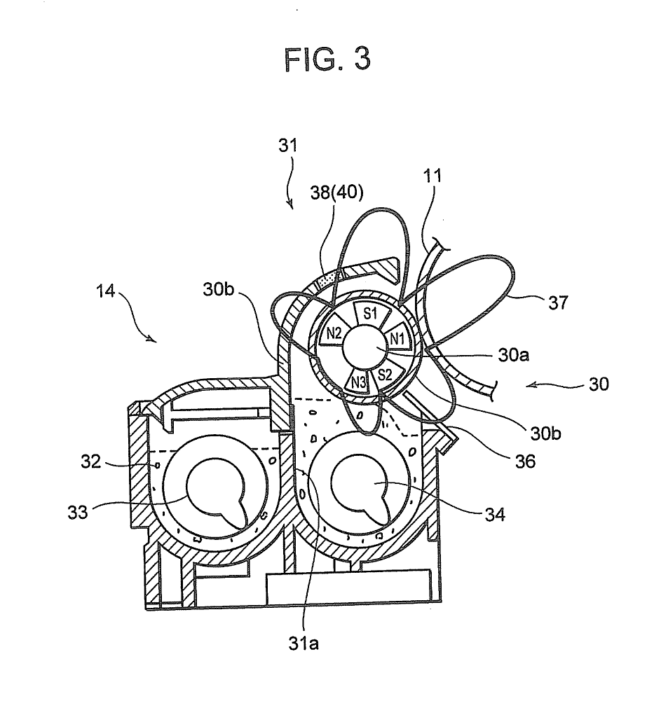

The developing roller 30 includes a cylindrical developing sleeve 30b made of a non-magnetic material, for example, aluminum around an outer periphery of a fixed magnet roller 30a. The developing sleeve 30b rotates in an arrow n direction. The magnet roller 30a includes a N-polarity developing magnetic pole N1, a S-polarity collecting magnetic pole S1, a N-polarity first peeling magnetic pole N2, a N-polarity second peeling magnetic pole N3, and a S-polarity supplying magnetic pole S2. The developing magnetic pole N1 is located at a development position opposite to the photoconductive drum 11. The magnet roller 30a forms magnetic lines of force 37 as shown in FIG. 3 for example, between the developing magnetic pole N1, the collecting magnetic pole S1, the first peeling magnetic pole N2, the second peeling magnetic pole N3, and the supplying magnetic pole S2.

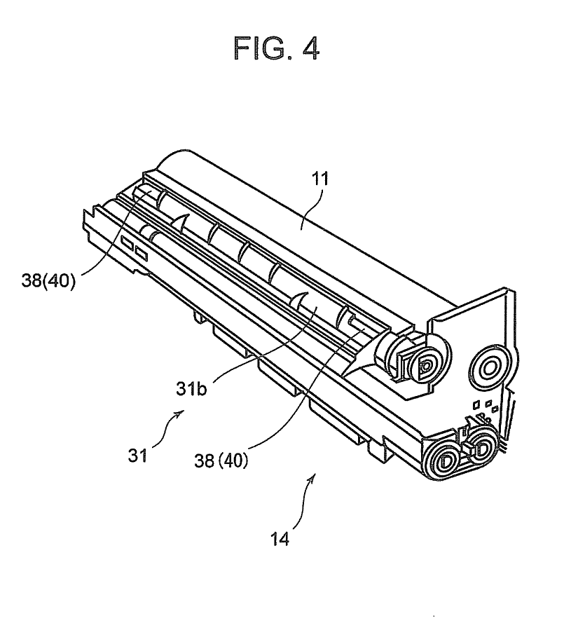

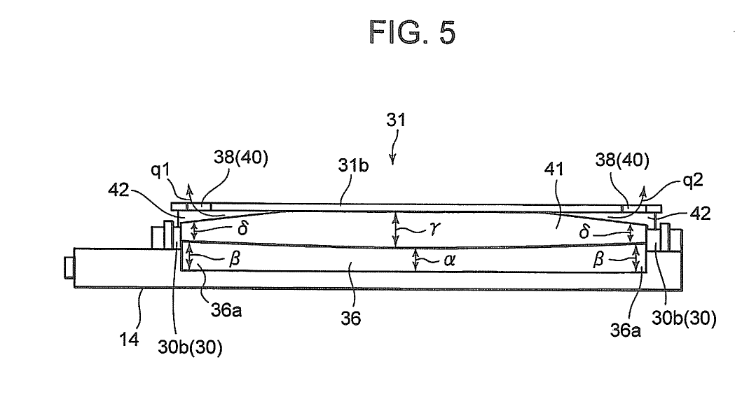

As shown in FIG. 4 and FIG. 5, the housing 31 includes a toner collecting part 38 that is disposed at both sides in a longitudinal direction of a cover 31b located downstream of the collecting magnetic pole S1 in the rotation direction of the developing sleeve 30b, and is a pressure reducing part, and communicates with the outside. The toner collecting part 38 is provided with an air filter 40 to collect floating toner.

The housing 31 includes a doctor blade 36 at a position opposite to the supplying magnetic pole S2 of the magnet roller 30a. A blade end 36a of the doctor blade 36 has a gentle curve shape in which a width β at both sides in the longitudinal direction is wide as compared with a width α at the center of the developing roller 30 in the longitudinal direction. The doctor blade 36 regulates a layer thickness of a magnetic brush-shaped developer layer 41 formed on the periphery of the developing sleeve 30b. The doctor blade 36 regulates the layer thickness of the developer layer 41 at the center of the developing roller 30 in the longitudinal direction to a thickness γ, and regulates the thickness of the developer layer 41 at both sides of the developing roller 30 in the longitudinal direction to a thickness δ thinner than γ. The doctor blade 36 regulates the thickness of the developer layer 41 to have a gentle curve shape in the longitudinal direction of the developing roller 30.

Since the layer thickness δ of the developer layer 41 formed around the developing sleeve 30b at both sides in the longitudinal direction is thin, a gap 42 between the cover 31b of the housing 31 and the developer layer 41 becomes wide at both sides of the developing roller 30 in the longitudinal direction. The housing 31 includes the toner collecting part 38 in the area of the wide gap 42 at both sides in the longitudinal direction.

When a print operation starts, in the developing device 14, the developing sleeve 30b rotates in the arrow n direction, and the developer 32 forms the developer layer 41 on the periphery of the developing sleeve 30b by the magnetic lines of force 37 of the magneto roller 30a. The developing sleeve 30b attracts the developer 32, which is being conveyed by the conveying mixer 34, by the second peeling magnetic pole N3 and the supplying magnetic pole S2 and forms the developer layer 41.

The developer layer 41 passes the doctor blade 36, so that the layer thickness is regulated, and the developer layer reaches the developing magnetic pole N1 opposite to the photoconductive drum 11. The developer layer 41 supplies the toner to the photoconductive drum 11 by the developing magnetic pole N1 and visualizes the electrostatic latent image. The developer layer 41 passing the developing magnetic pole N1 is collected into the housing 31 by the collecting magnetic pole S1. Further, the developer layer 41 is peeled from the developing sleeve 30b between the first peeling magnetic pole N2 and the second peeling magnetic pole N3, drops onto the conveying mixer 34 and is collected.

At the time of rotation of the developing sleeve 30b in the arrow n direction, an airflow in the arrow n direction equal to the rotation direction of the developing sleeve 30b is generated in the housing 31. The inner pressure of the housing 31 becomes higher than the atmospheric pressure by the airflow flowing into the housing 31. If the inner pressure of the housing 31 becomes high, airflow to discharge the air in a direction of low resistance is generated in the housing 31. In the housing 31, the gap 42 between the cover 31b and the developer layer 41 becomes wide at both sides of the developing roller 30 in the longitudinal direction, and the resistance to the airflow becomes small. Accordingly, in the housing 31, airflows q1 and q2 are generated from the center of the developing roller 30 in the longitudinal direction to both sides in the longitudinal direction.

The airflows q1 and q2 directed to both sides in the longitudinal direction in the housing 31 are discharged to the outside from the toner collecting parts 38 located downstream of the airflows q1 and q2. The inner pressure in the housing 31 is reduced. The air filters 40 collect floating toner included in the airflows q1 and q2 in the housing 31.

Accordingly, since the air flowing into the housing 31 at the time of rotation of the developing sleeve 30b is efficiently discharged from the toner collecting parts 38 located downstream of the airflows q1 and q2 by the airflows q1 and q2 directed to both sides in the longitudinal direction in the housing 31, the inner pressure of the housing 31 does not rise. Ejection of the air from a gap of the housing 31 due to the increase of the inner pressure of the housing 31 is prevented.

According to the first embodiment, the widths at both sides of the doctor blade 36 in the longitudinal direction are formed to be wide as compared with the width at the center in the longitudinal direction. The airflows q1 and q2 directed in the direction in which the gap 42 between the cover 31b and the developer layer 41 is wide are generated in the housing 31. The airflows q1 and q2 are efficiently discharged from the downstream toner collecting parts 38, and the inner pressure of the housing 31 is reduced. Besides, the air filters 40 efficiently collect the floating toner in the housing 31. The ejection of the airflow to the outside from a gap of the housing 31 is prevented, and the scattering of the floating toner to the outside is prevented.

### SECOND EMBODIMENT

Next, a second embodiment will be described. The second embodiment is different from the first embodiment in adjustment of a gap between a housing and a developer layer. In the second embodiment, the same structure as the structure described in the first embodiment is denoted by the same reference numeral and its detailed description will be omitted. In the second embodiment, the gap between the housing and the developer layer is adjusted by using the shape of the housing.

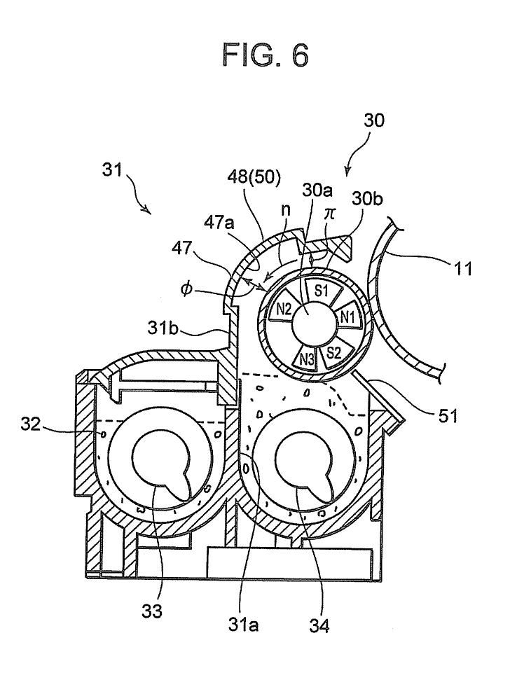

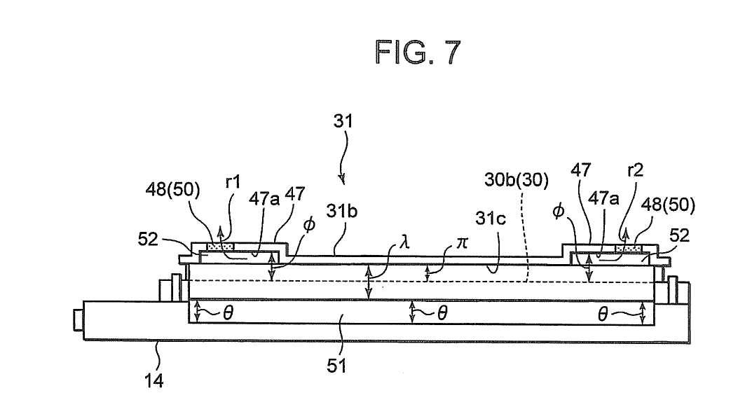

In the second embodiment, as shown in FIG. 6 and FIG. 7, a step 47 is formed at both sides of a cover 31b of a housing 31 in a longitudinal direction. The step 47 extends from the downstream side of a collecting magnetic pole S1 in a rotation direction of a developing sleeve 30b to the downstream side of a first peeling magnetic pole N2. An inner wall 47a of the step 47 is more separated from the developing sleeve 30b than a cover inner wall 31c at the center of the cover 31b in the longitudinal direction. The distance between the cover inner wall 31c at the center of the cover 31b in the longitudinal direction and the developing sleeve 30b is π, and the distance between the inner wall 47a of the step 47 and the developing sleeve 30b is φ larger than π. The step 47 includes a toner collecting part 48 communicating with the outside at both sides in the longitudinal direction. The toner collecting part 48 is provided with an air filter 50 to collect floating toner.

A doctor blade 51 has a uniform width θ over the whole length of the developing roller 30 in the longitudinal direction. The doctor blade 51 regulates a layer thickness of a magnetic brush-shaped developer layer 41 formed on the periphery of the developing sleeve 30b to a uniform thickness λ over the whole length in the longitudinal direction of the developing roller 30. By the step 47, the housing 31 includes a gap 52 between an inner wall 47a of the step 47 at both sides in the longitudinal direction and the developer layer 41.

When a print operation starts, in a developing device 14, the developing sleeve 30b rotates in an arrow n direction, and a developer 32 forms the developer layer 41 on the periphery of the developing sleeve 30b by magnetic lines of force 37 of a magneto roller 30a. In the developing sleeve 30b, a second peeling magnetic pole N3 and a supply magnetic pole S2 attracts the developer 32, which is being conveyed by a conveying mixer 34, to the developing sleeve 30b, and forms the developer layer 41.

When the inner pressure of the housing 31 becomes higher than the atmospheric pressure at the time of rotation of the developing sleeve 30b in the arrow n direction, an airflow to discharge the air in a direction of low resistance is generated in the housing 31. Since the gap 52 is formed by the step 47 in the housing 31, the resistance to the airflow at both sides of the developing roller 30 in the longitudinal direction decreases. Accordingly, in the housing 31, airflows r1 and r2 directed from the center of the developing roller 30 in the longitudinal direction to both sides in the longitudinal direction are generated.

The airflows r1 and r2 directed to both sides in the longitudinal direction in the housing 31 are discharged to the outside from the toner collecting parts 48 located downstream of the airflows r1 and r2. The air filters 50 collect floating toner included in the airflows r1 and r2 in the housing 31.

Accordingly, the air flowing into the housing 31 at the time of rotation of the developing sleeve 30b is efficiently discharged from the toner collecting parts 48 located downstream of the airflows r1 and r2 by the airflows r1 and r2 directed to both sides in the longitudinal direction in the housing 31. Thus, the inner pressure of the housing 31 does not increase. The ejection of the air from a gap of the housing 31 due to the increasing of the inner pressure of the housing 31 is prevented.

According to the second embodiment, the steps 47 are formed at both sides of the cover 31b of the housing 31 in the longitudinal direction. In the housing 31, the airflows r1 and r2 directed to the gap 52 between the inner wall 47a of the step 47 and the developer layer 41 are generated. The airflows r1 and r2 are efficiently discharged from the downstream toner collecting parts 48, and the inner pressure in the housing 31 is reduced. Besides, the air filters 50 efficiently collect the floating toner in the housing 31. The ejection of the airflow to the outside from a gap of the housing 31 is prevented, and the scattering of the floating toner to the outside is prevented.

According to at least one of the above embodiments, the airflow directed to the toner collecting part is generated in the housing of the developing device, the air in the housing is efficiently discharged from the toner collecting part, and the inner pressure in the housing is reduced. The scattering of toner to the outside of the developing device is prevented.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and their equivalents are intended to cover such forms of modifications as would fall within the scope and spirit of the invention.

What is claimed is:

1. A developing device comprising:
a developing roller that carries a developer and faces an image carrier;
a housing that supports the developing roller and supplies the developer to the developing roller; and
a pressure reducing part that exists downstream of an opposite position to the image carrier in a rotation direction of the developing roller, and is provided in a wall of the housing located downstream of an airflow generated in a gap between the developer on the developing roller and an inner wall of the housing.

2. The device of claim 1, wherein a size of the gap in the housing is changed in a longitudinal direction of the developing roller and to generate the airflow.

3. The device of claim 2, wherein a layer thickness of the developer on the developing roller is made irregular in the longitudinal direction of the developing roller and to change the size of the gap.

4. The device of claim 3, wherein the pressure reducing part is provided in the wall opposite to a position where the layer thickness of the developer is thin.

5. The device of claim 3, further comprising a doctor blade to regulate the layer thickness of the developer on the developing roller, wherein a width of the doctor blade is irregular in the longitudinal direction of the developing roller, and to make irregular the layer thickness of the developer.

6. The device of claim 5, wherein the width of the doctor blade is wide at both sides as compared with a center of the developing roller in the longitudinal direction.

7. The device of claim 2, wherein a step is provided in the inner wall of the housing in the longitudinal direction of the developing roller.

8. The device of claim 7, wherein the inner wall of the housing at both sides is separated from the developing roller as compared with a center of the developing roller in the longitudinal direction, and to provide the step.

9. An image forming apparatus comprising:
an image carrier;
a latent image forming part to form a latent image on the image carrier;
a developing roller that carries a developer and faces the image carrier;
a housing that supports the developing roller and supplies the developer to the developing roller; and
a pressure reducing part that exists downstream of an opposite position to the image carrier in a rotation direction of the developing roller, and is provided in a wall of the housing located downstream of an airflow generated in a gap between the developer on the developing roller and the inner wall of the housing.

10. The apparatus of claim 9, wherein a size of the gap in the housing is changed in a longitudinal direction of the developing roller and to generate the airflow is.

11. The apparatus of claim 10, wherein a layer thickness of the developer on the developing roller is irregular in the longitudinal direction of the developing roller and to change the size of the gap.

12. The apparatus of claim 11, wherein the pressure reducing part is formed in the wall opposite to a position where the layer thickness of the developer is thin.

13. The apparatus of claim 11, further comprising a doctor blade to regulate the layer thickness of the developer on the developing roller, wherein a width of the doctor blade is irregular in the longitudinal direction of the developing roller, and to make irregular the layer thickness of the developer.

14. The apparatus of claim 13, wherein the width of the doctor blade is made wide at both sides as compared with a center of the developing roller in the longitudinal direction.

15. The apparatus of claim 11, wherein a step is provided in the inner wall of the housing in the longitudinal direction of the developing roller.

16. The apparatus of claim 15, wherein the inner wall of the housing at both sides is separated from the developing roller as compared with a center of the developing roller in the longitudinal direction, and to provide the step.

17. An exhaust method of a developing device, comprising:
generating an airflow in a longitudinal direction of a developing roller in a housing;
forming a pressure reducing part in a wall of the housing at a downstream side of the airflow; and
discharging air in the housing from the pressure reducing part.

18. The method of claim 17, wherein the airflow is generated in the housing by changing a size of a gap between a developer on the developing roller and an inner wall of the housing in the longitudinal direction of the developing roller.
